(19) United States
(12) Patent Application Publication
(10) Pub. No.: US 2021/0291685 A1
(43) Pub. Date: Sep. 23, 2021

(54) CHARGING DEVICE

(71) Applicant: HONDA MOTOR CO., LTD., Tokyo (JP)

(72) Inventors: Noriyuki ABE, Saitama (JP); Yoshio KOJIMA, Saitama (JP)

(73) Assignee: HONDA MOTOR CO., LTD., Tokyo (JP)

(21) Appl. No.: 17/186,871

(22) Filed: Feb. 26, 2021

(30) Foreign Application Priority Data
Mar. 19, 2020 (JP) 2020-050280

(51) Int. Cl. B60L 53/51; H02J 7/00; H02J 7/35; H02J 7/34; B60L 50/60; B60L 53/62; B60L 53/55

(52) U.S. Cl. CPC B60L 53/51; H02J 7/0013; H02J 7/35; H02J 7/345; H02J 2207/50; B60L 50/60; B60L 53/62; B60L 53/55; H02J 2207/20; H02J 7/007

(57) ABSTRACT

A charging device that charges a battery having cells connected in series and configured as cell units, the charging device includes a solar battery, and a charging circuit configured to selectively supply electric power generated by the solar battery to each of the cell units. The charging circuit includes a first electric power adjustment unit configured to adjust electric power generated by the solar battery into first electric power, and output the first electric power, a second electric power adjustment unit configured to adjust the first electric power into second electric power, and supply the second electric power to each of the cell units, and a power storage unit provided between the first electric power adjustment unit and the second electric power adjustment unit and configured to store the first electric power output by the first electric power adjustment unit.

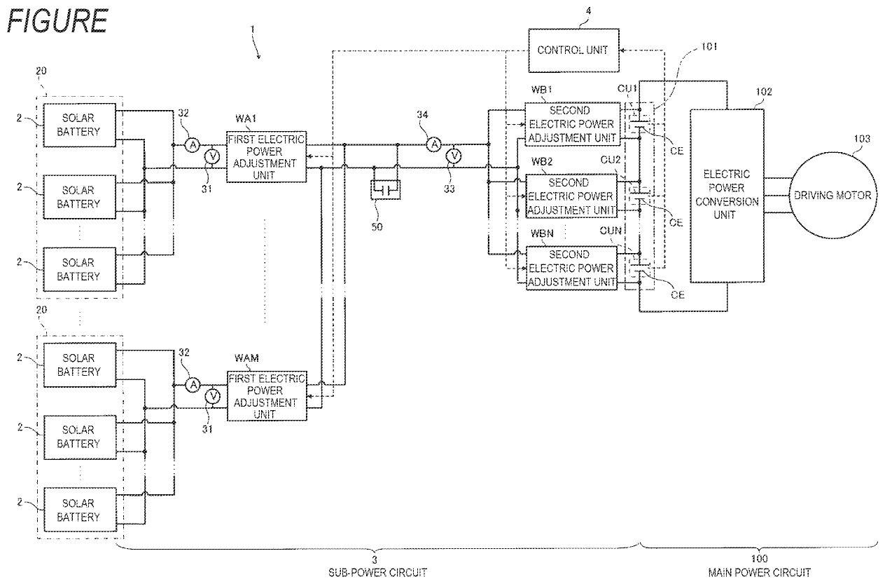

### CROSS REFERENCE TO RELATED APPLICATIONS

This application claims priority to Japanese Patent Application No. 2020-050280 filed on Mar. 19, 2020, the content of which is incorporated herein by reference.

### TECHNICAL FIELD

The present invention relates to a charging device that charges a capacitor with electric power generated by a solar battery.

### BACKGROUND ART

In recent years, various solar battery charging systems have been proposed in which a capacitor is charged with electric power generated by a solar battery. For example, JP 2014-217167 A discloses a technique in which a main battery that supplies electric power to a traveling electric motor, a solar battery, and a boost converter that boosts the electric power generated by the solar battery are provided, and the main battery is charged by boosting the electric power, that is generated by the solar battery, using the boost converter.

Power generation of the solar battery is easy to be affected by, for example, weather, and an output voltage may be unstable. A control of a converter that converts the electric power generated by the solar battery is performed using a charging voltage to a battery as a target voltage, but when the output voltage of the solar battery is unstable, the charging voltage to the battery also tends to be unstable. When the charging voltage is unstable, a charging control to the battery is unstable and the charging efficiency decreases. The charging voltage to the battery can be stabilized by widening a control range of the converter, but in that case, it is difficult to improve the charging efficiency because the power loss of the converter increases. The solar battery charging system described in JP 2014-217167 A does not always have sufficient measures in this regard, and there is a room for improvement in efficient charging of the battery.

An aspect of the present invention provides a charging device capable of stabilizing a voltage supplied from a solar battery to a battery and efficiently charging the battery with electric power generated by the solar battery.

### SUMMARY OF INVENTION

According to an aspect of the present invention, there is provided a charging device that charges a battery mounted in a vehicle, the battery having cells connected in series, the cells being configured as cell units each including at least one of the cells, the charging device including: a solar battery; and a charging circuit configured to selectively supply electric power generated by the solar battery to each of the cell units. The charging circuit includes: a first electric power adjustment unit configured to adjust electric power generated by the solar battery into first electric power, and output the first electric power, a second electric power adjustment unit configured to adjust the first electric power, which is output by the first electric power adjustment unit, into second electric power, and supply the second electric power to each of the cell units, and a power storage unit provided between the first electric power adjustment unit and the second electric power adjustment unit and configured to store the first electric power output by the first electric power adjustment unit.

### BRIEF DESCRIPTION OF DRAWINGS

The FIGURE is a block diagram showing a charging device according to an embodiment of the present invention.

### DESCRIPTION OF EMBODIMENTS

Hereinafter, an embodiment of a charging device of the present invention will be described with reference to the accompanying drawings.

As shown in the FIGURE, a charging device 1 of the present embodiment includes solar batteries 2, a sub-power circuit 3 (an example of a charging circuit), and a control unit 4. The charging device 1 is a device that charges a battery 101, which will be described later, with electric power generated by the solar battery 2. The charging device 1 is mounted in, for example, a vehicle such as an electric vehicle (EV) in which the solar battery 2 is provided on a roof, or a bonnet.

The battery 101 is connected to a main power circuit 100 and is a battery for driving a vehicle driving motor 103 (an example of an electric motor) provided in the main power circuit 100. The battery 101 is configured by connecting terminals of adjacent battery cell units such that a plurality of battery cell units CUn (n=1 to N) are electrically connected in series. Each battery cell unit CUn in the present embodiment is configured with, for example, a single battery cell CE. The battery 101 is configured as, for example, a cell stack in which a plurality of battery cells (battery cell units) and a plurality of insulating plates are alternately stacked. The battery 101 is, for example, a high-output battery having an output voltage of about several hundred [V], and in the high-output battery, about hundred to several hundred battery cells of various types each having an output voltage of about several [V], such as a nickel-metal hydride battery or a lithium ion battery, are connected. The battery 101 of the present embodiment is configured such that about 100 battery cells (battery cell units) each having an output voltage of about 3[V] are connected and an output voltage thereof is about 300[V]. The output voltage (charging voltage) of each battery cell unit CUn is detected by a battery sensor (not shown) and sent to the control unit 4.

The solar battery 2 converts solar light energy into electric energy. The solar battery 2 includes a solar battery cell that receives solar light and generates electric power, and is formed in, for example, a panel shape. The solar battery cell is implemented by a photodiode or the like. In order to obtain a required voltage, a plurality of solar battery cells are connected in series to form a solar battery cell string. Further, in order to obtain a required output, a plurality of solar battery cell strings may be connected in series or in parallel so as to be configured as a solar battery cell array. A plurality of solar batteries 2 are provided and these solar batteries 2 are connected in parallel. In the present embodiment, a set including 1 to 8 solar batteries 2 that are connected in parallel is formed into a solar battery unit 20, and about 30 solar battery units 20 are provided. An output voltage of each solar battery 2 is configured to be about 48[V].

The sub-power circuit 3 is provided between the solar battery 2 and the battery 101. The sub-power circuit 3 is a charging circuit for charging the battery 101 with electric power generated by the solar battery 2. The sub-power circuit 3 is configured to selectively supply the electric power of the solar battery 2 to each battery cell unit CUn among the plurality of battery cell units CUn (n=1 to N) configuring the battery 101. The sub-power circuit 3 includes a first electric power adjustment unit WAm (m=1 to M), a second electric power adjustment unit WBn (n=1 to N), voltage sensors 31, 33, current sensors 32, 34, and a buffer battery 50 (an example of a power storage unit).

The first electric power adjustment unit WAm adjusts the electric power generated by the solar battery 2 into first electric power, and outputs the first electric power to the second electric power adjustment unit WBn. Specifically, the first electric power adjustment unit WAm is implemented by a DC/DC converter with Maximum Power Point Tracking (MPPT), for example. Further, the first electric power adjustment unit WAm is provided for each solar battery unit 20, and the first electric power adjustment units WAm are connected in parallel. An output terminal of each first electric power adjustment unit WAm is connected to an input terminal of the second electric power adjustment unit WBn.

Based on the MPPT function, the first electric power adjustment unit WAm controls a voltage of the first electric power adjustment unit WAm such that the output electric power of the solar batteries 2 is maximized. That is, the first electric power adjustment unit WAm adjusts the electric power output from the solar batteries 2 such that the electric power output to the second electric power adjustment unit WBn follows an optimum operating point. Further, the first electric power adjustment unit WAm adjusts the voltage output from the solar batteries 2 into a predetermined voltage required by the second electric power adjustment unit WBn. In the present embodiment, the first electric power adjustment unit WAm steps down the voltage (about 48[V]) output from the solar batteries 2 to about 24[V]. The DC/DC converter is configured with a switching element, a diode, or the like.

The second electric power adjustment unit WBn adjusts the first electric power, which is output by the first electric power adjustment unit WAm, into second electric power according to a charging state of the battery cell unit CUn, and supplies the second electric power to the battery cell unit CUn.

Specifically, the second electric power adjustment unit WBn is implemented by a DC/DC converter. Then, the second electric power adjustment unit WBn (n=1 to N) is provided for each of the battery cell units CUn (n=1 to N) configuring the battery 101. Further, the same number of second electric power adjustment units WBn as the battery cell units CUn are provided, and output terminals of each second electric power adjustment unit WBn are connected to both end portions of each battery cell unit CUn, respectively.

That is, the second electric power adjustment unit WB1 is connected to the battery cell unit CU1, the second electric power adjustment unit WB2 is connected to the battery cell unit CU2, and the second electric power adjustment unit Wbn is connected to the battery cell unit Cun. The second electric power adjustment unit WB1 supplies the electric power generated by the solar batteries 2 to the battery cell unit CU1, the second electric power adjustment unit WB2 supplies the electric power generated by the solar batteries 2 to the battery cell unit CU2, and the second electric power adjustment unit Wbn supplies the electric power generated by the solar batteries 2 to the battery cell unit Cun. A set including each second electric power adjustment unit and each battery cell unit, for example, a set including the second electric power adjustment unit WB1 and the battery cell unit CU1, a set including the second electric power adjustment unit WB2 and the battery cell unit CU2, and a set including the second electric power adjustment unit WBn and the battery cell unit CUn are configured to be independent of one another. Accordingly, the respective second electric power adjustment units WBn are provided in a state of being insulated from one another.

Further, the second electric power adjustment unit WBn adjusts the voltage output from the first electric power adjustment unit WAm into a predetermined voltage required by a battery cell unit CUn. In the present embodiment, the second electric power adjustment unit WBn steps down the voltage (about 24[V]) output from the first electric power adjustment unit WAm to about 3[V]. The DC/DC converter is configured with a switching element, a diode, or the like.

The voltage sensor 31 detects a voltage to be output to the first electric power adjustment unit WAm from the solar batteries 2. Voltage information of the detected voltage is sent to the control unit 4. The current sensor 32 detects a current flowing to the first electric power adjustment unit WAm from the solar batteries 2. Current information of the detected current is sent to the control unit 4. The voltage sensor 33 detects a voltage to be output to the second electric power adjustment unit WBn from the first electric power adjustment unit WAm. Voltage information of the detected voltage is sent to the control unit 4. The current sensor 34 detects a current flowing to the second electric power adjustment unit WBn from the first electric power adjustment unit WAm. Current information of the detected current is sent to the control unit 4.

The buffer battery 50 is connected between the first electric power adjustment unit WAm and the second electric power adjustment unit WBn, that is, between the DC/DC converter with MPPT and the DC/DC converter for charging (distribution). The buffer battery 50 is connected between the output terminals of the first electric power adjustment units WAm, that is, the input terminals of the second electric power adjustment units WBn. The buffer battery 50 is provided so as to be able to store the electric power output from the first electric power adjustment unit WAm. The buffer battery 50 is implemented by a condenser, a capacitor, a lithium ion battery, or the like. Further, the buffer battery 50 has, for example, a storage capacity by which a fluctuation range of the voltage output from the first electric power adjustment unit WAm is controlled within a predetermined range.

The control unit 4 controls operations of the first electric power adjustment unit WAm and the second electric power adjustment unit WBn. The battery sensor of each battery cell unit CUn configuring the battery 101, each first electric power adjustment unit WAm, each second electric power adjustment unit WBn, the voltage sensors 31, 33, the current sensors 32, 34, or the like are electrically connected to the control unit 4. The control unit 4 controls the first electric power adjustment unit WAm based on, for example, voltage values detected by the voltage sensors 31, 33 and current values detected by the current sensors 32, 34. Further, based on the output voltage (charging voltage) of each battery cell unit CUn detected by the battery sensor of each battery cell unit CUn, the control unit 4 controls the second electric power adjustment unit WBn corresponding to each battery cell unit CUn such that the voltages of the battery cell units are substantially equal to one another. For example, the control unit 4 calculates an average charge amount of all the battery cell units CUn, and detects a battery cell unit CUn having a charge amount smaller than the calculated average charge amount. The control unit 4 selectively controls the second electric power adjustment unit WBn corresponding to the battery cell unit CUn, in which the detected charge amount is small, such that the electric power of the solar batteries 2 is preferentially supplied to the battery cell unit CUn.

The main power circuit 100 is connected to the battery 101, and includes an electric power conversion unit 102 and the driving motor 103. The configuration and function of the battery 101 are as described above. The electric power conversion unit 102 converts a direct current output from the battery 101 into an alternating current (for example, a three-phase current) and supplies the alternating current to the driving motor 103. The driving motor 103 is a motor that functions as a driving source for driving a vehicle.

According to the charging device 1 having such a configuration, the buffer battery 50 is provided between an output portion of the first electric power adjustment unit WAm and an input portion of the second electric power adjustment unit WBn, and thus the fluctuation in voltage output from the first electric power adjustment unit WAm can be absorbed (reduced) due to electricity storage of the buffer battery 50. As a result, the voltage output from the first electric power adjustment unit WAm can be stabilized, and the stabilized voltage can be supplied to the second electric power adjustment unit WBn. Therefore, the voltage supplied from the solar batteries 2 to the battery 101 can be stabilized and the battery 101 can be efficiently charged with the electric power generated by the solar batteries 2. Further, since the stabilized voltage is supplied to the second electric power adjustment unit WBn, the control on the charging voltage to the battery cell unit CUn by the second electric power adjustment unit WBn is stable, and a control range of the second electric power adjustment unit WBn can be narrowed. As a result, a capacity of the second electric power adjustment unit WBn can be reduced, and the cost and size of the second electric power adjustment unit WBn can be reduced.

Further, based on the MPPT function of the first electric power adjustment unit WAm, the electric power generated by the solar batteries 2 can be controlled to be maximized, so that an amount of electric power generated by the solar batteries 2 can be increased.

Further, by using any of a condenser, a capacitor, and a lithium ion battery as the buffer battery 50, the electric power output from the first electric power adjustment unit WAm is stabilized, and the stabilized voltage can be supplied to the second electric power adjustment unit WBn.

Since the battery 101 is connected to the electric power conversion unit 102 capable of supplying electric power of the battery 101 to the driving motor 103 for driving a vehicle, the driving motor 103 of the vehicle can be driven by the electric power of the battery 101.

The above-described embodiments can be appropriately modified, improved, or the like.

For example, in the embodiment described above, each of the battery cell units CUn configuring the battery 101 is formed by a single battery cell CE, but each battery cell unit may be formed as a battery module in which a plurality of battery cells CE are stacked and integrated. Therefore, the battery 101 can be efficiently charged with the electric power generated by the solar batteries 2 in units of battery module.

For example, in the embodiment described above, one second electric power adjustment unit WBn is provided for each of the battery cell units CUn configuring the battery 101, but one second electric power adjustment unit may be provided for n battery cell units (2≤n<N. Here, N is the number of all battery cell units.).

At least the following matters are described in the present specification. It should be noted that although corresponding components in the above embodiment are shown in parentheses, the present invention is not limited thereto.

(1) A charging device (charging device 1) that charges a battery (battery 101) mounted in a vehicle, of the battery having cells (battery cells CE) connected in series, the cells being configured as cell units (battery cell units CUn (n=1 to N)) each including at least one of the cells, the charging device including:

a solar battery (solar battery 2); and

a charging circuit (sub-power circuit 3) configured to selectively supply electric power generated by the solar battery to each of the cell units, wherein

the charging circuit includes:
a first electric power adjustment unit (first electric power adjustment unit WAm (m=1 to M)) configured to adjust electric power generated by the solar battery into first electric power, and output the first electric power,
a second electric power adjustment unit (second electric power adjustment unit WBn (n=1 to N)) configured to adjust the first electric power, which is output by the first electric power adjustment unit, into second electric power, and supply the second electric power to each of the cell units, and
a power storage unit (buffer battery 50) provided between the first electric power adjustment unit and the second electric power adjustment unit and configured to store the first electric power output by the first electric power adjustment unit.

According to the above (1), in the charging circuit that can supply the electric power generated by the solar battery to each cell unit, a power storage unit capable of storing the electric power output from the first electric power adjustment unit is provided between the first electric power adjustment unit and the second electric power adjustment unit. Therefore, a voltage output from the first electric power adjustment unit can be stabilized by the power storage unit, and the stabilized voltage can be supplied to the second electric power adjustment unit. Therefore, the voltage supplied from the solar battery to the battery can be stabilized and the battery can be efficiently charged with the electric power generated by the solar battery.

(2) The charging device according to the above (1), wherein

the first electric power adjustment unit operates such that electric power generated by the solar battery is maximized.

According to the above (2), since the first electric power adjustment unit operates such that the electric power generated by the solar battery is maximized, the electric power generated by the solar battery can be increased.

(3) The charging device according to (1) or (2), wherein

the power storage unit includes at least one of a condenser, a capacitor, and a lithium ion battery.

According to the above (3), by using any of a condenser, a capacitor, and a lithium ion battery as the power storage unit, the electric power output from the first electric power adjustment unit can be stabilized.

(4) The charging device according to any one of the above (1) to (3), wherein

the battery is connected to a main power circuit (main power circuit 100) configured to supply electric power of the battery to an electric motor (driving motor 103) configured to drive the vehicle.

According to the above (4), since the battery is connected to the main power circuit configured to supply electric power of the battery to the electric motor configured to drive the vehicle, the electric motor can be driven by the electric power of the battery.

What is claimed is:

1. A charging device that charges a battery mounted in a vehicle, the battery having cells connected in series, the cells being configured as cell units each including at least one of the cells, the charging device comprising:
a solar battery; and
a charging circuit configured to selectively supply electric power generated by the solar battery to each of the cell units, wherein
the charging circuit includes:
a first electric power adjustment unit configured to adjust electric power generated by the solar battery into first electric power, and output the first electric power,
a second electric power adjustment unit configured to adjust the first electric power, which is output by the first electric power adjustment unit, into second electric power, and supply the second electric power to each of the cell units, and
a power storage unit provided between the first electric power adjustment unit and the second electric power adjustment unit and configured to store the first electric power output by the first electric power adjustment unit.

2. The charging device according to claim 1, wherein
the first electric power adjustment unit operates such that electric power generated by the solar battery is maximized.

3. The charging device according to claim 1, wherein
the power storage unit includes at least one of a condenser, a capacitor, and a lithium ion battery.

4. The charging device according to claim 1, wherein
the battery is connected to a main power circuit configured to supply electric power of the battery to an electric motor configured to drive the vehicle.
